(19) United States
(12) Patent Application Publication
(10) Pub. No.: US 2019/0013133 A1
(43) Pub. Date: Jan. 10, 2019

(54) COIL COMPONENT

(71) Applicant: Murata Manufacturing Co., Ltd., Kyoto-fu (JP)

(72) Inventor: Katsufumi SASAKI, Nagaokakyo-shi (JP)

(73) Assignee: Murata Manufacturing Co., Ltd., Kyoto-fu (JP)

(21) Appl. No.: 16/028,684

(22) Filed: Jul. 6, 2018

(30) Foreign Application Priority Data
Jul. 10, 2017 (JP) 2017-134361

(51) Int. Cl. H01F 17/00; H01F 27/28; H01F 27/29; H01F 27/32

(52) U.S. Cl. CPC H01F 17/0013; H01F 27/2804; H01F 2017/0093; H01F 27/32; H01F 2017/004; H01F 27/292

(57) ABSTRACT

A coil component includes a first magnetic body, an insulator stacked on the first magnetic body, a second magnetic body stacked on the insulator, and a coil which is disposed in the insulator and which includes a first coil conductor layer and a second coil conductor layer that are arranged in the stacking direction of the first magnetic body, the insulator, and the second magnetic body. In a cross section in the stacking direction, the shapes of the first coil conductor layer and the second coil conductor layer are polygonal, and regarding opposing portions of the first coil conductor layer and the second coil conductor layer that face each other, one opposing portion is a side and the other opposing portion is a vertex.

### CROSS-REFERENCE TO RELATED APPLICATION

This application claims benefit of priority to Japanese Patent Application No. 2017-134361, filed Jul. 10, 2017, the entire content of which is incorporated herein by reference.

### BACKGROUND

### Technical Field

The present disclosure relates to a coil component.

### Background Art

An existing coil component is described in Japanese Unexamined Patent Application Publication No. 2016-213333. The coil component includes a first magnetic body, an insulator stacked on the first magnetic body, a second magnetic body stacked on the insulator, and a coil disposed in the insulator. The coil includes a first coil conductor layer and a second coil conductor layer that are arranged in the stacking direction of the first magnetic body, the insulator, and the second magnetic body.

When the coil component in the related art is produced and used, cracks may occur in the insulator. Specifically, cracks occur in the insulator, and as a result, a crack from a vertex of the first coil conductor layer and a crack from a vertex of the second coil conductor layer are connected to each other, where the vertices face each other.

The present inventor intensively investigated this phenomenon and, as a result, found that stress was concentrated in the insulator around each of the vertices of the first coil conductor layer and the second coil conductor layer so as to generate cracks and that a crack from a vertex of the first coil conductor layer and a crack from a vertex of the second coil conductor layer were connected to each other because the distance between the vertices was small.

### SUMMARY

Accordingly, the present disclosure provides a coil component in which the occurrence of cracks spanning two coil conductor layers in the insulator can be suppressed.

According to preferred embodiments of the present disclosure, a coil component includes a first magnetic body, an insulator stacked on the first magnetic body, a second magnetic body stacked on the insulator, and a coil which is disposed in the insulator and which includes a first coil conductor layer and a second coil conductor layer that are arranged in the stacking direction of the first magnetic body, the insulator, and the second magnetic body. In a cross section in the stacking direction, the shapes of the first coil conductor layer and the second coil conductor layer are polygonal. Regarding opposing portions of the first coil conductor layer and the second coil conductor layer that face each other, one opposing portion is a side and the other opposing portion is a vertex.

The side that is the one opposing portion and that is basically linear may be curved. The vertex that is the other opposing portion may be an acute angle or curved. In the coil component according to an embodiment of the present disclosure, in a cross section in the stacking direction, regarding the opposing portions of the first coil conductor layer and the second coil conductor layer that face each other, the one opposing portion is a side and the other opposing portion is a vertex. As a result, the distance between the vertex of the first coil conductor layer and the vertex of the second coil conductor layer can be increased compared with the case where the opposing portion of each of the first coil conductor layer and the second coil conductor layer is a side. Consequently, even when stress is concentrated in the insulator around the vertices of each of the first coil conductor layer and the second coil conductor layer and cracks occur, the cracks from the two vertices are not easily connected to each other. Therefore, a short circuit of the first coil conductor layer and the second coil conductor layer due to migration can be suppressed.

In the coil component according to an embodiment of the present disclosure, the number of vertices of a polygon with respect to each of the first coil conductor layer and the second coil conductor layer is an odd number. According to this embodiment, the number of vertices of a polygon with respect to each of the first coil conductor layer and the second coil conductor layer is an odd number. Therefore, when the shapes of the first coil conductor layer and the second coil conductor layer are the same, one opposing portion can be set to be a side, and the other opposing portion can be set to be a vertex easily.

In the coil component according to an embodiment of the present disclosure, the vertices of a polygon with respect to each of the first coil conductor layer and the second coil conductor layer are curved. According to this embodiment, the vertices of a polygon with respect to each of the first coil conductor layer and the second coil conductor layer are curved. Therefore, stress concentration in the insulator around the vertices of the coil conductor layer can be reduced, and the occurrence of cracks in the insulator can be suppressed.

In the coil component according to an embodiment of the present disclosure, in a cross section in the stacking direction, at least part of the second coil conductor layer overlaps, in the stacking direction, the first coil conductor layer adjacent to the second coil conductor layer. According to this embodiment, in a cross section in the stacking direction, at least part of the second coil conductor layer overlaps, in the stacking direction, the first coil conductor layer. Therefore, distances from the vertices at either end of the side that is the one opposing portion to the vertex of the other opposing portion can be made almost equal. Consequently, cracks are not easily connected to each other compared with the case where the distances are different from each other.

In the coil component according to an embodiment of the present disclosure, in a cross section in the stacking direction, at least part of the second coil conductor layer overlaps, in the stacking direction, the insulator located between two first coil conductor layers adjacent to the second coil conductor layer. According to this embodiment, in a cross section in the stacking direction, at least part of the second coil conductor layer overlaps, in the stacking direction, the insulator located between two first coil conductor layers adjacent to the second coil conductor layer. Therefore, distances from the vertices at either end of the side that is the one opposing portion to the respective vertices of the other opposing portion can be made almost equal. Consequently, cracks are not easily connected to each other compared with the case where the distances are different from each other.

Further, the capacitance between the first coil conductor layer and the second coil conductor layer can be reduced. As a result, matching of characteristic impedance and an increase in cutoff frequency can be facilitated.

In the coil component according to an embodiment of the present disclosure, in a cross section in the stacking direction, the relationship between the width W and the thickness T of each of the first coil conductor layer and the second coil conductor layer satisfies W<T. According to this embodiment, a coil conductor layer that can pass a large current can be formed by increasing the thickness T without changing the width W.

In the coil component according to an embodiment of the present disclosure, in a cross section in the stacking direction, the relationship between the width W and the thickness T of each of the first coil conductor layer and the second coil conductor layer satisfies W>T. According to this embodiment, the number of coil conductor layers can be increased by decreasing the thickness T without changing the height of the coil component.

In the coil component according to an embodiment of the present disclosure, in a cross section in the stacking direction, the side that is the one opposing portion has a recessed portion. According to this embodiment, the distance between the first coil conductor layer and the second coil conductor layer can be increased in the recessed portion of the side that is the one opposing portion, and the capacitance between the first coil conductor layer and the second coil conductor layer can be reduced. As a result, matching of characteristic impedance and an increase in cutoff frequency can be facilitated.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view showing a coil component according to a first embodiment of the present disclosure;

FIG. 2 is a sectional view showing a coil component;

FIG. 3 is an exploded perspective view showing a coil component;

FIG. 4 is a diagram showing a magnified part of FIG. 2;

FIG. 5 is a diagram of a magnified coil component in the related art;

FIG. 6 is a sectional view showing another embodiment of a coil conductor layer;

FIG. 7 is a schematic diagram showing a plurality of coil conductor layers;

FIG. 8 is a sectional view showing a coil component according to a second embodiment of the present disclosure;

FIG. 9A is a sectional view showing a coil component according to a third embodiment of the present disclosure;

FIG. 9B is a sectional view showing a coil component according to a third embodiment of the present disclosure;

FIG. 10 is a sectional view showing a coil component according to a fourth embodiment of the present disclosure; and

FIG. 11 is a schematic diagram showing a coil conductor layer.

### DETAILED DESCRIPTION

The present disclosure will be described below in detail with reference to the embodiments shown in the drawings.

### First Embodiment

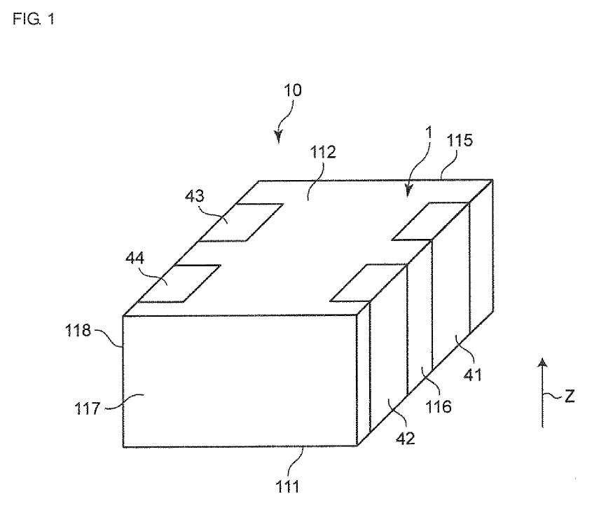

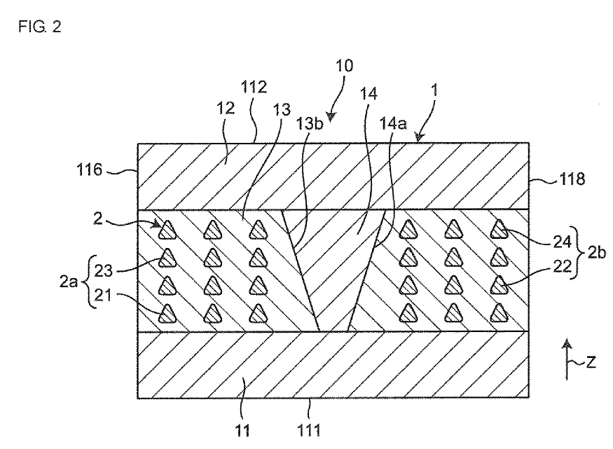

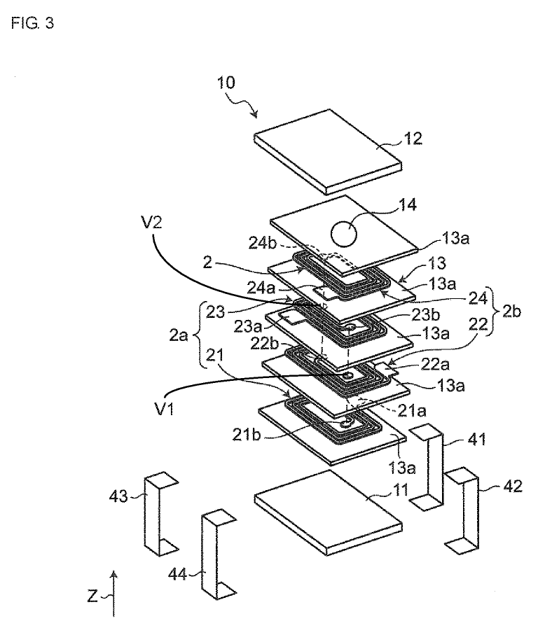

FIG. 1 is a perspective view showing a coil component according to a first embodiment of the present disclosure. FIG. 2 is a sectional view showing the coil component. FIG. 3 is an exploded perspective view showing the coil component. As shown in FIG. 1, FIG. 2, and FIG. 3, a coil component 10 includes a multilayer body 1, a coil 2 disposed in the multilayer body 1, and first to fourth outer electrodes 41 to 44 disposed on the multilayer body 1.

The coil component 10 is a common mode choke coil. The coil component 10 may be mounted in electronic equipment, e.g., a personal computer, a DVD player, a digital camera, a TV, a cellular phone, and car electronics.

The multilayer body 1 includes a first magnetic body 11, an insulator 13 stacked on the first magnetic body 11, a second magnetic body 12 stacked on the insulator 13, and an internal magnetic body 14 disposed in the insulator 13. The stacking direction of the first magnetic body 11, the insulator 13, and the second magnetic body 12 is the Z-direction indicated by an arrow. The first magnetic body 11 is located at a lower position, and the second magnetic body 12 is located at an upper position.

The first magnetic body 11, the internal magnetic body 14, and the second magnetic body 12 are composed of, for example, Ni—Cu—Zn-based ferrite, providing favorable high-frequency impedance characteristics. The insulator 13 is composed of, for example, glass containing borosilicate glass, the dielectric constant can be decreased, the stray capacitance of the coil 2 can be reduced, and favorable high-frequency characteristics can be provided. The insulator 13 is formed by stacking a plurality of insulating layers 13a on each other.

The internal magnetic body 14 is disposed within the inner circumference of the coil 2 in the insulator 13 and is connected to the first magnetic body 11 and the second magnetic body 12. In a cross section in the stacking direction, the width of the internal magnetic body 14 increases continuously from the first magnetic body 11 side toward the second magnetic body 12 side. Specifically, a hole 13b that passes through the insulator 13 in the stacking direction is located within the inner circumference of the coil 2. The internal magnetic body 14 is disposed in the hole 13b. The inner diameter of the hole 13b increases continuously from the first magnetic body 11 side toward the second magnetic body 12 side.

The multilayer body 1 is formed so as to have a shape of a substantially rectangular parallelepiped. The surface of the multilayer body 1 includes a first end surface 111, a second end surface 112, a first side surface 115, a second side surface 116, a third side surface 117, and a fourth side surface 118. The first end surface 111 and the second end surface 112 are located at opposing positions in the stacking direction. The first to fourth side surfaces 115 to 118 are located at positions between the first end surface 111 and the second end surface 112. The first end surface 111 is located at a lower position, and the second end surface 112 is located at an upper position.

The coil 2 includes a primary coil 2a and a secondary coil 2b magnetically coupled to each other. The primary coil 2a and the secondary coil 2b are disposed in the insulator 13 and arranged in the stacking direction.

The primary coil 2a includes a first coil conductor layer 21 and a third coil conductor layer 23 electrically connected to each other. The secondary coil 2b includes a second coil conductor layer 22 and a fourth coil conductor layer 24 electrically connected to each other.

The first to fourth coil conductor layers 21 to 24 are arranged sequentially in the stacking direction. That is, two coil conductor layers 21 and 23 of the primary coil 2a and two coil conductor layers 22 and 24 of the secondary coil 2b are arranged alternately in the stacking direction. The first to fourth coil conductor layers 21 to 24 are disposed on the respective insulating layers 13a different from each other. The first to fourth coil conductor layers 21 to 24 are composed of an electrically conductive material, for example, Ag, Cu, Au, or Ni, or an alloy containing any one of the metals as a primary component.

The first to fourth coil conductor layers 21 to 24 have a spiral pattern and are spiral windings on a plane when viewed from above. The center axes of each of the first to fourth coil conductor layers 21 to 24 are in accord with each other when viewed from above.

In a cross section in the stacking direction, at least part of the second coil conductor layer 22 overlaps, in the stacking direction, the first coil conductor layer 21 adjacent to the second coil conductor layer 22. As a result, distances from the vertices at either end of the flat surface that is the opposing portion of the second coil conductor layer 22 to the vertex that is the opposing portion of the first coil conductor layer 21 can be made almost equal. Consequently, cracks are not easily connected to each other compared with the case where the distances are different from each other. In this regard, the same may apply to the third and fourth coil conductor layers 23 and 24, respectively.

A first end 21a of the first coil conductor layer 21 extends to the outer circumference, and a second end 21b of the first coil conductor layer 21 is located at the inner circumference. Likewise, the second coil conductor layer 22 has a first end 22a and a second end 22b, the third coil conductor layer 23 has a first end 23a and a second end 23b, and the fourth coil conductor layer 24 has a first end 24a and a second end 24b.

The first end 21a of the first coil conductor layer 21 is exposed at the second side surface 116 at a position close to the first side surface 115. The first end 22a of the second coil conductor layer 22 is exposed at the second side surface 116 at the position close to the third side surface 117. The first end 23a of the third coil conductor layer 23 is exposed at the fourth side surface 118 at the position close to the first side surface 115. The first end 24a of the fourth coil conductor layer 24 is exposed at the fourth side surface 118 at the position close to the third side surface 117.

The second end 21b of the first coil conductor layer 21 is electrically connected to the second end 23b of the third coil conductor layer 23 via the via conductor, V1 which passes through the insulating layer 13a that is interposed therebetween. Likewise, the second end 22b of the second coil conductor layer 22 is electrically connected to the second end 24b of the fourth coil conductor layer 24 via the via conductor V2, which passes through the insulating layer 13a that is interposed therebetween.

The first to fourth outer electrodes 41 to 44 are composed of an electrically conductive material, for example, Ag, Ag—Pd, Cu, or Ni. The first to fourth outer electrodes 41 to 44 are formed by, for example, coating the surface of the multilayer body 1 with the electrically conductive material and performing baking. Each of the first to fourth outer electrodes 41 to 44 is formed into a substantially U shape.

The first outer electrode 41 is disposed on the second side surface 116 at the position close to the first side surface 115. One end portion of the first outer electrode 41 that extends from the second side surface 116 is disposed on the first end surface 111 by bending, and the other end portion of the first outer electrode 41 that extends from the second side surface 116 is disposed on the second end surface 112 by bending. The first outer electrode 41 is electrically connected to the first end 21a of the first coil conductor layer 21.

Likewise, the second outer electrode 42 is disposed on the second side surface 116 at the position close to the third side surface 117 and is electrically connected to the first end 22a of the second coil conductor layer 22. The third outer electrode 43 is disposed on the fourth side surface 118 at the position close to the first side surface 115 and is electrically connected to the first end 23a of the third coil conductor layer 23. The fourth outer electrode 44 is disposed on the fourth side surface 118 at the position close to the third side surface 117 and is electrically connected to the first end 24a of the fourth coil conductor layer 24.

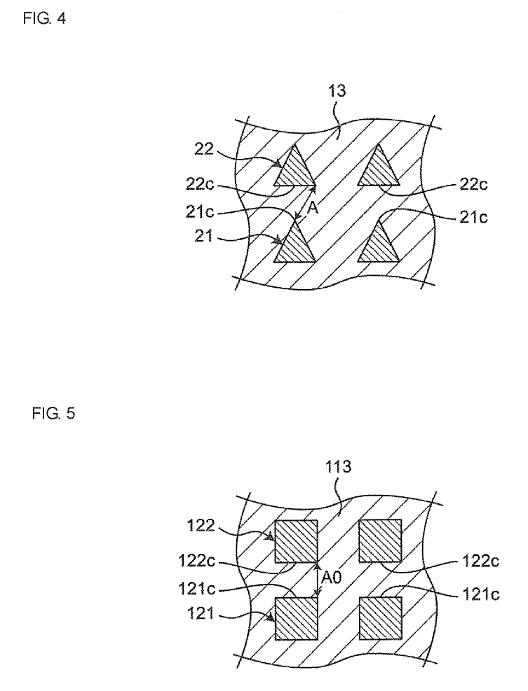

FIG. 4 is a diagram showing a magnified part of FIG. 2. As shown in FIG. 4, in the cross section in the stacking direction, each shape of the first coil conductor layer 21 and the second coil conductor layer 22 is substantially polygonal. Specifically, each shape of the first coil conductor layer 21 and the second coil conductor layer 22 is substantially triangular and protrudes toward the second magnetic body 12 (upper side). The first coil conductor layer 21 and the second coil conductor layer 22 will be described below, and the same applies to the third coil conductor layer 23 and the fourth coil conductor layer 24.

The first coil conductor layer 21 includes an opposing portion 21c that faces the second coil conductor layer 22 in the stacking direction. The second coil conductor layer 22 includes an opposing portion 22c that faces the first coil conductor layer 21 in the stacking direction. The opposing portion 21c of the first coil conductor layer 21 is a vertex. The angle of the opposing portion 21c is an acute angle. The opposing portion 22c of the second coil conductor layer 22 is a side. The side that is the opposing portion 22c is a flat surface.

The opposing portion 21c of the first coil conductor layer 21 is a vertex, and the opposing portion 22c of the second coil conductor layer 22 is a flat surface. Therefore, the distance A between the vertex of the first coil conductor layer 21 and a vertex located at an end portion of the flat surface of the second coil conductor layer 22 can be increased compared with the case where the opposing portions of the first coil conductor layer 21 and the second coil conductor layer 22 that face each other are flat surfaces. Consequently, even when stress is concentrated on the insulator 13 around the vertices of each of the first coil conductor layer 21 and the second coil conductor layer 22 and cracks occur, the cracks from the vertices are not easily connected to each other. Therefore, a short circuit of the first coil conductor layer 21 and the second coil conductor layer 22 due to migration can be suppressed.

In addition, the distance A between the vertex of the first coil conductor layer 21 and the vertex of the second coil conductor layer 22 can be increased without reducing the cross-sectional areas of the first and second coil conductor layers 21 and 22 to a great extent, and the characteristic impedance can be arbitrarily changed without influencing the characteristics, e.g., Rdc, to a great extent.

On the other hand, according to Japanese Unexamined Patent Application Publication No. 2016-213333, as shown in FIG. 5, an opposing portion 121c of a first coil conductor layer 121 and an opposing portion 122c of a second coil conductor layer 122 are sides. As a result, the distance A0 between the vertex located at an end portion of a side of the first coil conductor layer 121 and the vertex located at an end portion of a side of the second coil conductor layer 122 is decreased. Therefore, stress may be concentrated in an insulator 113 around the vertices of each of the first coil conductor layer 121 and the second coil conductor layer 122 and cracks may occur and, as a result, the cracks from the vertices may be connected to each other. Consequently, a short circuit of the first coil conductor layer 121 and the second coil conductor layer 122 due to migration may occur.

Even if the sides of the first coil conductor layer 121 and the second coil conductor layer 122 are curved, the vertices are located at the end portions of the sides. Therefore, the vertex of the first coil conductor layer 121 and the vertex of the second coil conductor layer 122 approach each other, and cracks from the two vertices may be connected to each other.

As shown in FIG. 4, the number of vertices of a polygon with respect to each of the first coil conductor layer 21 and the second coil conductor layer 22 is an odd number. Therefore, when the shapes of the first coil conductor layer 21 and the second coil conductor layer 22 are the same, one opposing portion 22c can be set to be a side, and the other opposing portion 21c can be set to be a vertex easily.

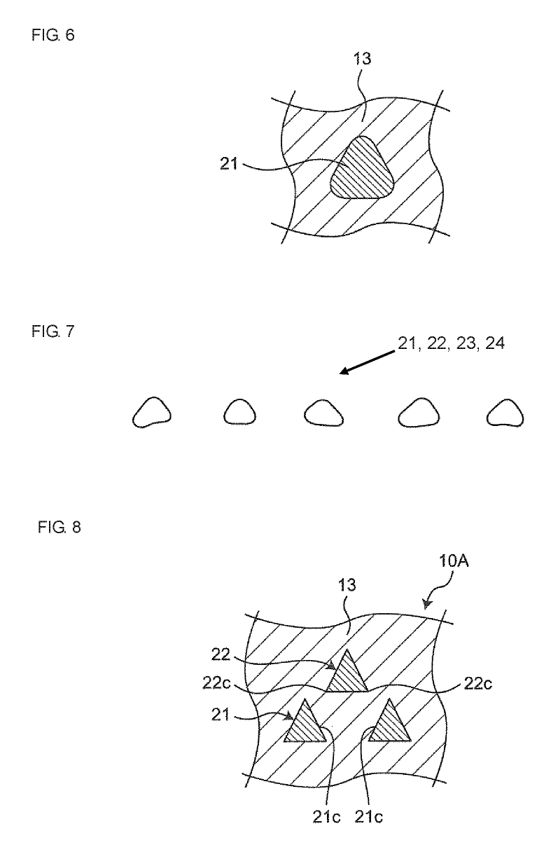

As shown in FIG. 6, the vertices of a polygon with respect to the first coil conductor layer 21 may be curved. Consequently, stress concentration in the insulator 13 around the vertices of the first coil conductor layer 21 can be reduced, and the occurrence of cracks in the insulator 13 can be suppressed. In this regard, the sides of a polygon of the first coil conductor layer 21 may be curved. The same may apply to the second to fourth coil conductor layers 22 to 24.

FIG. 7 is a schematic diagram showing a plurality of coil conductor layers, such as any of coil conductor layers 21 to 24, the diagram being drawn on the basis of the images observed by an optical microscope. The shapes of actual coil conductor layers 21 to 24 are various shapes shown in, for example, FIG. 7, and “substantially triangular” includes these shapes. The shapes of the first to fourth coil conductor layers 21 to 24 may be substantially polygonal other than triangular. At this time, the side that is basically linear may be curved, and the vertex may be an acute angle or a curved.

Next, a method for manufacturing the coil component 10 will be described.

As shown in FIG. 2 and FIG. 3, a plurality of insulating layers 13a provided with the respective coil conductor layers 21 to 24 are stacked sequentially on the first magnetic body 11. As a result, the insulator 13 in which the coil 2 is disposed is stacked on the first magnetic body 11.

Thereafter, a laser is applied from above the insulator 13 downward so as to form a hole 13b that vertically passes through the insulator 13. The hole 13b may be formed by mechanical processing other than the laser.

Subsequently, the resulting hole 13b is filled with the internal magnetic body 14, and the second magnetic body 12 is stacked on the insulator 13 so as to form the multilayer body 1. Then, the multilayer body 1 is fired, and the outer electrodes 41 to 44 are formed on the multilayer body 1 so as to produce the coil component 10.

### Second Embodiment

FIG. 8 is a sectional view showing a coil component 10A according to a second embodiment of the present disclosure. The second embodiment is different from the first embodiment in a configuration of the coil conductor layer. The difference in the configuration will be described below. Other configurations are the same as the configurations in the first embodiment and indicated by the same reference numerals as those in the first embodiment, and explanations thereof will not be provided.

As shown in FIG. 8, regarding a coil component 10A according to a second embodiment, in the cross section in the stacking direction, at least part of the second coil conductor layer 22 overlaps, in the stacking direction, the insulator located between two first coil conductor layers 21 adjacent to the second coil conductor layer. At this time, the opposing portion 21c of the first coil conductor layer 21 that faces the second coil conductor layer 22 is a side, and the opposing portion 22c of the second coil conductor layer 22 that faces the first coil conductor layer 21 is a vertex.

Therefore, in the cross section in the stacking direction, when the second coil conductor layer 22 is made to overlap, in the stacking direction, the insulator located between two first coil conductor layers 21 adjacent to the second coil conductor layer 22, distances from the vertices at either end of the flat surface that is the opposing portion of the second coil conductor layer 22 to the respective vertices of the opposing portions of two first coil conductor layers 21 can be made almost equal. Consequently, cracks are not easily connected to each other compared with the case where the distances are different from each other.

Further, the capacitance between the first coil conductor layer 21 and the second coil conductor layer 22 can be reduced. As a result, matching of characteristic impedance and an increase in cutoff frequency can be facilitated. In this regard, the same may apply to the third coil conductor layer 23 and the fourth coil conductor layer 24, and the same may apply to the second coil conductor layer 22 and the third coil conductor layer 23.

### Third Embodiment

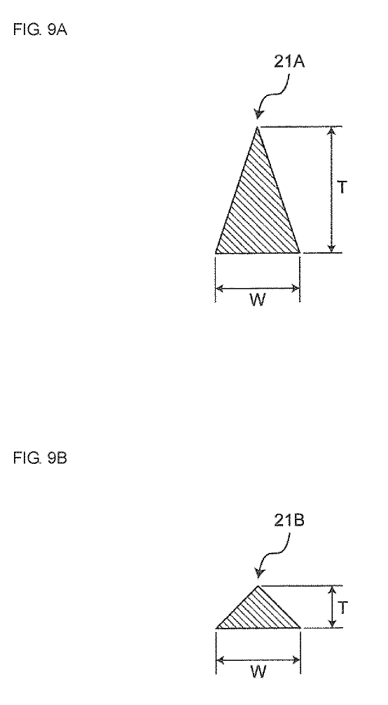

FIG. 9A and FIG. 9B are sectional views showing a coil component according to a third embodiment of the present disclosure. The coil conductor layer 21A in FIG. 9A and the coil conductor layer 21B in FIG. 9B are different in the aspect ratio.

As shown in FIG. 9A, in the cross section in the stacking direction, the relationship between the width W and the thickness T of a first coil conductor layer 21A satisfies W<T. The width W is a size in the direction orthogonal to the stacking direction, and the thickness T is the size in the stacking direction. Therefore, the first coil conductor layer 21A that can pass a large current can be formed by increasing the thickness T without changing the width W. In this regard, the same may apply to the second to fourth coil conductor layers 22 to 24, respectively.

As shown in FIG. 9B, in a cross section in the stacking direction, the relationship between the width W and the thickness T of a first coil conductor layer 21B satisfies W>T. Therefore, the number of coil conductor layers constituting the coil can be increased by decreasing the thickness T without changing the height of the coil component. In this regard, the same may apply to the second to fourth coil conductor layers 22 to 24, respectively.

### Fourth Embodiment

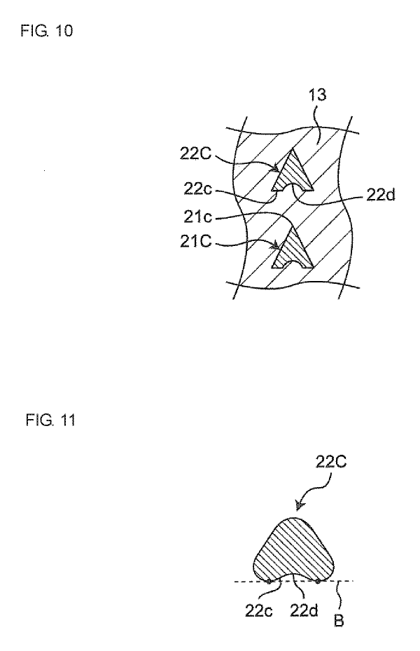

FIG. 10 is a sectional view showing a coil component according to a fourth embodiment of the present disclosure. As shown in FIG. 10, in a cross section in the stacking direction, the side that is an opposing portion 22c of the second coil conductor layer 22C has a recessed portion 22d. Specifically, each of the lower side of a first coil conductor layer 21C and the lower side of the second coil conductor layer 22C has a recessed portion.

Therefore, the distance between the first coil conductor layer 21C and the second coil conductor layer 22C can be increased in the recessed portion 22d of the side that is the opposing portion 22c of the second coil conductor layer 22C, and the capacitance between the first coil conductor layer 21C and the second coil conductor layer 22C can be reduced. As a result, matching of characteristic impedance and an increase in cutoff frequency can be facilitated.

FIG. 11 is a schematic diagram showing a second coil conductor layer drawn on the basis of the image observed by an optical microscope. The shape of the second coil conductor layer 22C is, for example, a shape shown in FIG. 11. The side that is the opposing portion 22c of the second coil conductor layer 22C has a recessed portion 22d. At this time, the opposing portion 22c comes into contact with a plane B at two points. In this regard, the same may apply to the first, third, and fourth coil conductor layers.

### Example

Next, an example of the first embodiment will be described.

The coil conductor layer 21 to 24 is formed by plating in which a resist is used such that a cross-sectional shape becomes a substantially mushroom-like shape. More specifically, a support substrate having electrical conductivity is prepared, a resist is formed on a portion of the support substrate excluding a transfer region that has a predetermined pattern, and a plating electrode having a thickness larger than the thickness of the resist is formed in the transfer region. In this case, the plating electrode protrudes from the upper surface of the resist and, as a result, the cross section has a substantially mushroom-like shape. To facilitate peeling of the coil conductor layer 21 to 24 from the resist, preferably, the resist is tapered such that the cavity increases from the lower side toward the upper side in the height direction. The coil conductor layer 21 to 24 is primarily composed of Ag and may contain oxides, e.g., Al₂O₃ and SiO₂, as additives.

Meanwhile, magnetic layers and insulating layers composed of Ni—Cu—Zn-based ferrite, alkali borosilicate glass, a composite material of alkali borosilicate glass and Ni—Cu—Zn-based ferrite, or the like are prepared. Via holes that connect between the coils are formed in the insulating layers and filled with an electrically conductive material containing Ag.

Thereafter, the coil conductor layer 21 to 24 formed by plating is transferred to the insulating layer so as to prepare a sheet provided with the coil conductor layer 21 to 24. The coil conductor layer 21 to 24 is transferred in reverse and, thereby, has a substantially mushroom-like shape that protrudes upward.

After the magnetic layers are stacked, a predetermined numbers of insulating layers, to which the coil conductor layers 21 to 24 have been transferred, are stacked on the magnetic layers. Subsequently, a hole is formed within the inner circumference of the coil conductor layer 21 to 24 by a laser. The taper angle of the hole is set to be about 45 degrees or more and 70 degrees or less (i.e., from about 45 degrees to 70 degrees) and, as a result, processing can be performed with laser energy that does not pass through the lower magnetic layer even when a hole that passes through the insulating layer having a thickness of about 80 μm or more is formed.

If the minimal distance between the inner circumferential portion of the coil conductor layer 21 to 24 and the laser hole is excessively small, fine cracks occur in the insulator (insulating layer) around the coil conductor layer 21 to 24 due to energy during laser processing. Therefore, the distance is preferably about 100 μm or more. The same applies to a land portion for via connection in addition to the inner circumferential portion of the coil conductor layer 21 to 24. The hole may be formed by sandblast treatment or the like.

Thereafter, the resulting hole is filled with a magnetic paste so as to form an internal magnetic body 14 that protrudes downward. The magnetic layers are successively stacked so as to produce a multilayer body. The multilayer body is pressure-bonded by a method of isostatic press or the like and is cut so as to produce a chip-like multilayer body.

When the chip-like multilayer body is fired at about 870° C. to 910° C., glass in the insulator 13 is sufficiently softened and tends to become spherical due to surface tension. Meanwhile, tensile stress is applied to the coil conductor layer 21 to 24 in the direction toward the center due to sintering and, thereby, the vertices of the coil conductor layer 21 to 24 are rounded in accordance with the stress relationship between the insulator and the coil conductor layer 21 to 24. As a result, the shape of the coil conductor layer 21 to 24 becomes a substantially triangular shape with round vertices from a substantially mushroom-like shape that protrudes upward. A round electrode may be formed by reducing the electrode dimension that protrudes from the resist.

A state, in which sintering of the internal magnetic body 14 is facilitated while shrinkage due to softening of glass is suppressed and shrinkage becomes significant, can be produced by decreasing the firing temperature to about 870° C. and controlling the firing atmosphere so as to form a gap between the glass (insulator) and the internal magnetic body 14. In addition, the stress applied to the internal magnetic body can be reduced and, thereby, cracks do not easily occur in the internal magnetic body 14. It is preferable that the pore area percentages of the internal magnetic body 14 and the first and second magnetic bodies be about 15% or less and the pore diameter be about 1.5 μm or less.

The pore diameter and the pore area percentage were measured as described below.

A portion of the internal magnetic body 14, the first magnetic body 11, or the second magnetic body 12 in a cross section of the coil component 10 (refer to FIG. 2) was mirror-polished and was subjected to focused ion beam micromachining (FIB micromachining) (FIB apparatus: FIB200TEM produced by FEI). Thereafter, observation was performed by a scanning electron microscope (FE-SEM: JSM-7500FA produced by JEOL LTD.), and the pore diameter and the pore area percentage were measured. These were calculated by using image processing software (WINROOF Ver. 5.6 produced by MITANI CORPORATION).

The conditions for the focused ion beam micromachining and observation by FE-SEM were as described below.

Focused Ion Beam Micromachining (FIB Micromachining) Condition
A polished surface of the mirror-polished sample was subjected to FIB micromachining at an incident angle of 5°.

Scanning Electron Microscope (SEM) Observation Condition
Acceleration voltage: 15 kV
Sample inclination: 85°
Signal: secondary electron
Coating: Pt
Magnification: 20,000 times

The pore diameter and the pore area percentage were determined by the following method in which image processing software was used.

The measurement range of the image was specified as about 15 μm×15 μm. The image obtained by FE-SEM was subjected to binarization and only pores were extracted. The area of each pore was measured, each pore measured was assumed to be a perfect circle, and the diameter thereof was calculated and taken as the pore diameter. The area of the measurement range and the pore area were calculated by using a “Total area and Number measurement” function of the image processing software, and the proportion of the pore area per area of the measurement range (pore area percentage) was determined.

Burrs were removed by barreling the chip after firing. Outer electrodes 41 to 44 were formed by being applied and baked. Subsequently, the outer electrodes 41 to 44 were subjected to plating of Ni, Cu, Sn, or the like. After the plating, the surface was coated with a silane-coupling-based water-repellent agent to prevent reduction in insulation resistance between the outer electrodes 41 to 44 under the influence of moisture and impurities in the atmosphere.

According to the above-described example, regarding the coil conductor layer 21 to 24 formed by plating, the cross section of the coil conductor layer 21 to 24 after firing can be made to have a shape with round vertices or a substantially triangular shape with round vertices by controlling the height and the taper of the resist and/or the height of the plating electrode that protrudes from the resist.

When ferrite is used for the magnetic layer and glass is used for the insulating layer, favorable high-frequency characteristics can be provided. When the taper angle of the internal magnetic body 14 is set to be about 45 degrees to 70 degrees, a thick magnetic path can be formed, the impedance can be high, and variations in the impedance can be reduced. When the firing process is controlled, it is possible to form a gap between the internal magnetic body 14 and the insulator 13 (glass) so as to reduce the stress applied to the internal magnetic body 14.

When the internal magnetic body 14 approaches the inner circumference of the coil conductor layer 21 to 24, the size of the insulator 13 between the internal magnetic body 14 and the inner circumference of the coil conductor layer 21 to 24 is reduced. The strength itself is reduced and, as a result, cracks easily occur due to thermal stress. However, the strength can be ensured by setting the dimension between the internal magnetic body 14 and the inner circumference of the coil conductor layer 21 to 24 to be about 100 μm or more.

In this regard, the present disclosure is not limited to the above-described embodiments, and the design can be changed within the bounds of not departing from the gist of the present disclosure. For example, the feature of each of the first to fourth embodiments may be variously combined.

In the above-described embodiments, each of the primary coil 2a and the secondary coil 2b is composed of two coils. However, at least one of the primary coil 2a and the secondary coil 2b may be composed of one coil or three or more coils.

In the above-described embodiments, the common mode choke coil is used as the coil component 10 and 10A. However, a single coil may be used. The coil includes four coil conductor layers 21 to 24 but has only to include at least two coil conductor layers (i.e., two of coil conductor layers 21 to 24). The shapes of all the coil conductor layers 21 to 24 are the same. However, the shape of at least one coil conductor layer 21 to 24 may be different from the shapes of the other coil conductor layers 21 to 24. In addition, the internal magnetic body 14 is disposed in the multilayer body, but the internal magnetic body 14 may be omitted.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A coil component comprising:
a first magnetic body;
an insulator stacked on the first magnetic body;
a second magnetic body stacked on the insulator; and
a coil which is disposed in the insulator and includes a first coil conductor layer and a second coil conductor layer that are arranged in a stacking direction of the first magnetic body, the insulator, and the second magnetic body,
wherein,
in a cross section in the stacking direction, shapes of the first coil conductor layer and the second coil conductor layer are polygonal, and
regarding opposing portions of the first coil conductor layer and the second coil conductor layer that face each other, one opposing portion is a side and an other opposing portion is a vertex.

2. The coil component according to claim 1, wherein a number of vertices of a polygon with respect to each of the first coil conductor layer and the second coil conductor layer is an odd number.

3. The coil component according to claim 1, wherein the vertices of a polygon with respect to each of the first coil conductor layer and the second coil conductor layer are curved.

4. The coil component according to claim 1, wherein, in a cross section in the stacking direction, at least part of the second coil conductor layer overlaps, in the stacking direction, the first coil conductor layer adjacent to the second coil conductor layer.

5. The coil component according to claim 1, wherein, in a cross section in the stacking direction, at least part of the second coil conductor layer overlaps, in the stacking direction, the insulator located between two first coil conductor layers adjacent to the second coil conductor layer.

6. The coil component according to claim 1, wherein, in a cross section in the stacking direction, a relationship between a width W and a thickness T of each of the first coil conductor layer and the second coil conductor layer satisfies W<T.

7. The coil component according to claim 1, wherein, in a cross section in the stacking direction, a relationship between a width W and a thickness T of each of the first coil conductor layer and the second coil conductor layer satisfies W>T.

8. The coil component according to claim 1, wherein, in a cross section in the stacking direction, a side that is the one opposing portion has a recessed portion.

9. The coil component according to claim 2, wherein the vertices of a polygon with respect to each of the first coil conductor layer and the second coil conductor layer are curved.

10. The coil component according to claim 2, wherein, in a cross section in the stacking direction, at least part of the second coil conductor layer overlaps, in the stacking direction, the first coil conductor layer adjacent to the second coil conductor layer.

11. The coil component according to claim 3, wherein, in a cross section in the stacking direction, at least part of the second coil conductor layer overlaps, in the stacking direction, the first coil conductor layer adjacent to the second coil conductor layer.

12. The coil component according to claim 2, wherein, in a cross section in the stacking direction, at least part of the second coil conductor layer overlaps, in the stacking direction, the insulator located between two first coil conductor layers adjacent to the second coil conductor layer.

13. The coil component according to claim 3, wherein, in a cross section in the stacking direction, at least part of the second coil conductor layer overlaps, in the stacking direction, the insulator located between two first coil conductor layers adjacent to the second coil conductor layer.

14. The coil component according to claim 2, wherein, in a cross section in the stacking direction, a relationship between a width W and a thickness T of each of the first coil conductor layer and the second coil conductor layer satisfies W<T.

15. The coil component according to claim 3, wherein, in a cross section in the stacking direction, a relationship between a width W and a thickness T of each of the first coil conductor layer and the second coil conductor layer satisfies W<T.

16. The coil component according to claim 4, wherein, in a cross section in the stacking direction, a relationship between a width W and a thickness T of each of the first coil conductor layer and the second coil conductor layer satisfies W<T.

17. The coil component according to claim 2, wherein, in a cross section in the stacking direction, a relationship between a width W and a thickness T of each of the first coil conductor layer and the second coil conductor layer satisfies W>T.

18. The coil component according to claim 3, wherein, in a cross section in the stacking direction, a relationship between a width W and a thickness T of each of the first coil conductor layer and the second coil conductor layer satisfies W>T.

19. The coil component according to claim 2, wherein, in a cross section in the stacking direction, a side that is the one opposing portion has a recessed portion.

20. The coil component according to claim 3, wherein, in a cross section in the stacking direction, a side that is the one opposing portion has a recessed portion.
